(19) United States
(12) Patent Application Publication
(10) Pub. No.: US 2004/0266535 A1
(43) Pub. Date: Dec. 30, 2004

(54) Method for creating a sports league and playing interactive league games

(76) Inventor: Allen Reeves, Tampa, FL (US)

Correspondence Address: ARTHUR W. FISHER, III, Suite 316, 5553 West Waters Avenue, Tampa, FL, 33634, US

(21) Appl. No.: 10/852,052

(22) Filed: May 24, 2004

Related U.S. Application Data
(60) Provisional application No. 60/479,504, filed on Jun. 19, 2003.

(51) Int. Cl. G06F 19/00; G06F 17/00

(52) U.S. Cl. 463/42

(57) ABSTRACT

A method and apparatus implements a sophisticated virtual game which can be set up as teams participating in a league applicable to sports and other scenarios such as geo-political scenario simulation wherein the teams participate in virtual games and can fully control their actions, plays, reactions and strategies, a game controller or game coordinator engine program administers games and executes strategies and plays determined by the opponents in real time or programmed in advance and stored for access by the game coordinator engine and the teams can also participate in player drafts and other activities including logo design and player trades.

### CROSS REFERENCE

This is a non-provisional application of provisional application Ser. No. 60/479,504 filed Jun. 19, 2003.

### BACKGROUND OF THE INVENTION

1. Field of the Invention

The invention relates to remote simulations in general. In particular, the invention relates to a network based method and apparatus for simulating conditions and circumstances relevant to a particular scenario. The method and apparatus of the invention is particularly relevant in conducting virtual games, such as sports games, war games, and evacuation scenario planning.

2. Description of the Prior Art

Techniques and equipment for playing video games on standalone computers have been available for some time. More recently, games have become available that allow users to play against each other over a computer network, such as a local area network or the Internet. Such games, however, typically put the fortunes and skills of various players against each other without including a central planning element. Such games lack the ability to simulate advanced planning and resource allocation among the players. Moreover, Internet play against one or more opponents does not provide the user a “franchise ownership” experience. “Fantasy” sports games which often offer cash prizes, allow players to form teams and select team members from active professional athletes. Such fantasy sports games allocate points to each player based on the actual performance of the selected team members in real professional sporting events. Such fantasy games do not provide the player an opportunity to design and implement strategies or actually play a virtual game.

### SUMMARY OF THE INVENTION

A method and apparatus according to the invention utilizes network based computers to set up a virtual league of teams with scheduled games that can be viewed by players and spectators. A purchaser of a team or franchise has rights to participate in player drafts, design his own logo, create and store plays, practice the plays at a virtual training facility, conduct a game and execute strategies in real time. A method and apparatus according to the invention also allows the franchisee to store profiles that will execute as directed by the franchisee at appropriate times, for example when the franchisee is unavailable to participate in a scheduled game. The franchisee can also create profiles to manage activities during a player draft.

The method and apparatus according to the invention can be applied to any number of games and simulations. For example, a method and apparatus according to the invention can be used to set up sports game leagues in basketball, football, baseball, hockey, gulf; tennis, and any other competitive sport. Similarly, a method and apparatus of the invention can be used to conduct virtual simulations of war games involving multiple players with various assets. Another application of a method and apparatus according to the invention could include emergency scenario planning and evacuation planning. In each case, a system according to the invention would allow a user or planner to execute strategies in response to externally driven events over which the user or planner has no control and only those assets that the user or planner has acquired prior to initiation of a particular game or a simulation scenario.

### BRIEF DESCRIPTION OF THE DRAWINGS

For a fuller understanding of the nature and object of the invention, reference should be had to the following detailed description taken in connection with the accompanying drawings in which:

FIG. 1 illustrates a hierarchy for a league based gaming system;

FIG. 2 is an overview of a process according to the invention for implementing a virtual football league;

FIG. 3 illustrates a sample registration form for the league based hierarchy;

FIG. 4 is an architectural overview of a system according to the invention;

FIG. 5 illustrates a network based interconnection infrastructure according to the invention;

FIG. 6 illustrates a high level menu illustrating options available to a system user;

FIG. 7 illustrates a logo creator display;

FIG. 8 illustrates a draft lottery display;

FIG. 9 illustrates a sample player draft selection display;

FIG. 10 illustrates a sample playbook editor display;

FIG. 11 illustrates a sample game film coordinator display with game synopsis;

FIG. 12 illustrates a standings display for a virtual league according to the invention showing standings and various conferences;

FIG. 13 illustrates a game schedule display.

FIG. 14 illustrates a sample prize structure for the league.

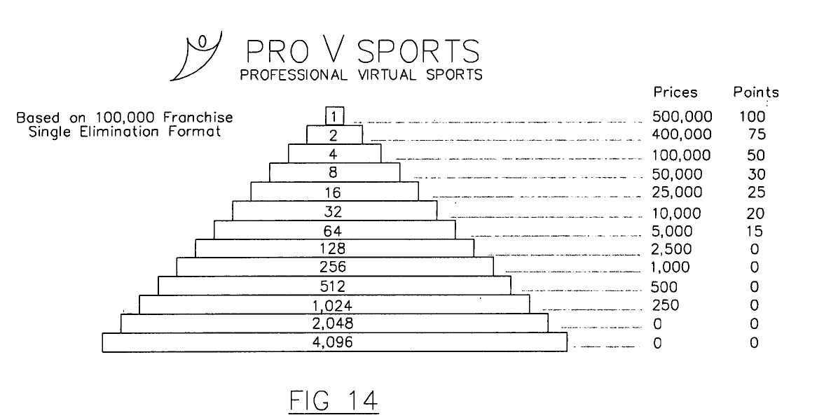

Similar reference characters refer to similar parts throughout the several views of the drawings.

### DETAILED DESCRIPTION OF THE PREFERRED EMBODIMENTS

As previously noted a method and apparatus according to the invention can be used to simulate scenarios in numerous contexts. For purposes of illustration, and not limitation, a method and apparatus according to the invention will be described herein with reference to a virtual football league. Those of ordinary skill will recognize that the methods and apparatus disclosed herein can be applied to other sports and non-sports scenarios.

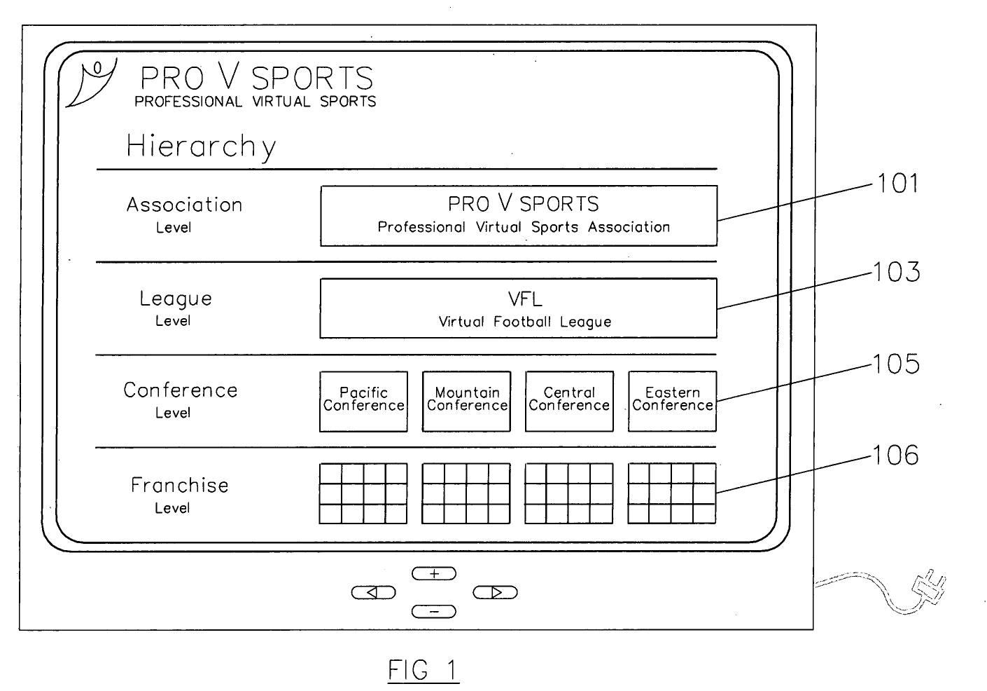

A method and apparatus according to the invention seeks to use the capabilities of networked computing to create a virtual sports game league, for example a virtual football league. A consumer would purchase software code consisting of programmed indicia on a medium, such as a compact disk, which the purchaser would then download onto a computing device, such as a personal computer or console. Operating code and libraries, if necessary, would be uploaded from the compact disk to the computer's operational memory. Alternatively, the program content of a compact disk can be downloaded via a network connection, such as the Internet to the user's computer. As is well known in the art, the operational program can be executed in libraries referenced as needed to conduct the game and run the virtual scenario. FIG. 1 illustrates an organizational hierarchy for a virtual sports league that can be implemented by a method and apparatus according to the invention. The top level 101 is an association level which operates one or more leagues. League level 103 reports directly to the association. Conference level 105 consists of a number of conferences to accommodate the number of users. FIG. 1 illustrates four conferences, a pacific conference, mountain conference, central conference and eastern conference, generally corresponding to the time zones of the United States. However, those of ordinary skill will recognize that any number of conferences can be implemented in a system using a method and apparatus according to the invention. Each team is assigned to a conference having at least a first predetermined number of teams and no more than a second predetermined number of teams such as 8 and 32 respectively. In any event, the total number of teams assigned to a conference is determined by dividing the total number of teams available by 2ⁿ, when n is a whole number.

Franchise level 106 includes individual teams which play against each other within their conference. The number of teams is determined by the number of franchise owners at the sign up date deadline. Determination of a conference champion would be determined by the team that wins the conference through a single elimination play-off system. It would be within the scope of the invention to permit playoffs within the conferences. The invention is not limited by rules for determining the identity of playoff participants or the identity of the conference champion.

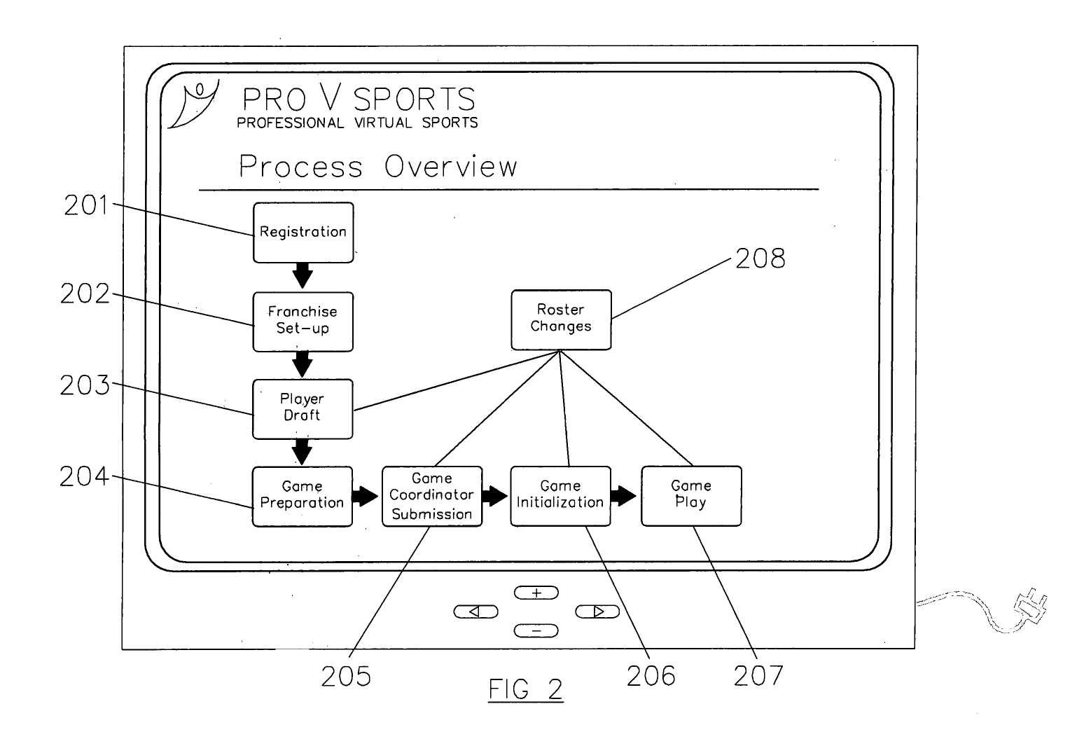

FIG. 2 illustrates an overview of the process of implementing a virtual football league using a method and apparatus according to the invention.

As a preliminary matter, those of ordinary skill will recognize that upon activation, the software could be programmed to communicate identification information, such as a serial number, to a server which would verify the authenticity of the game software. Alternatively, the game could be sold as a standalone version without user participation in a league over a network. In that case, in order to participate in the league over a network, the server would prompt the user for charge authorization information, such as a credit card number. Having completed this process, the user could begin to register the franchise.

FIG. 2 provides an overview of the virtual football league process according to the invention. In process 201, the user will register his franchise. The rights of a franchisee include the right to name the team, to sell the team to another franchisee, and to create his own logo or to use an existing logo, which the franchisee can then import onto virtual training facilities, practice fields, home fields, helmets, tee shirts and uniforms. Another right of the franchisee is to create his or her own plays using play editor features of the method and apparatus according to the invention.

Still another right of the franchisee is to draft players from a conference pool. As discussed further herein, a lottery chooses where the franchisee is in a draft and operates in reverse order per round.

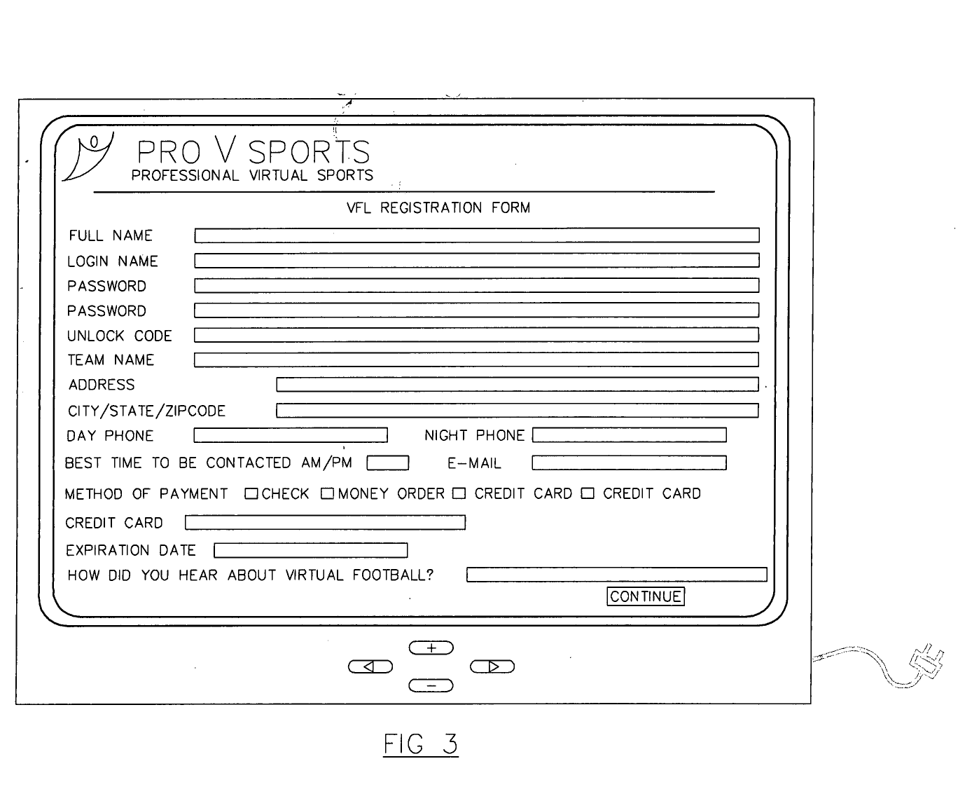

In the registration process 201, a number of activities take place. The user will be prompted to name the team and the server will collect information, such as identity and contact information, passwords and other codes. FIG. 3 illustrates such a sample registration form. The franchisee will then be placed in one of the conferences corresponding to the league being organized at the time of the registration. The league will have a franchise deadline set up, with the draft lottery taking place shortly after the franchise deadline. The college draft, which will be a multi-round draft such as a seven round draft, will take place about two weeks after the draft lottery and the a multi-round supplemental draft such as a 45 round draft, will take place a week after the college draft. There are no limitations to the number of leagues, conferences and franchises which can exist at any time.

Upon completion of the registration process, the activities in process 202 of franchise setup and configuration can take place. In process 202, the franchisee has the option of creating a team logo or using an existing one. The franchisee can then import that logo onto virtual training facilities and practice fields, a home field, player uniforms and locker rooms. According to the invention, a record or “game film” of each game played is maintained on a server. At franchise setup and configuration, the franchisee can be prompted to purchase a game film package which would allow the franchisee access to a display of the games played by all the franchisees in the conference or league. This allows the franchisee to observe the game film as part of planning strategies for competing against other teams in upcoming games. Alternatively, the team can purchase or select the game film option or package to setup.

After the teams are setup and configured, process 203 to draft players can commence. As discussed further herein, franchise owners are placed in the draft by lottery and each round is done in the reverse order of the previous round. After completing the draft, the franchise owner will have a team of players that can be deployed in individual games. The system is programmed to store statistics for each player. The statistics can be based on the statistics of actual players in professional football leagues or can be developed by the league or association to provide a pool of players with different capabilities and skill levels. For example, the skill set of certain players might be programmed to correspond to quarterbacks of various skill levels, while the skill sets of other players could be programmed to reflect the abilities of a running back, or a defensive end. Those of ordinary skill will recognize that different skill sets and different positions apply to different sports. The particular skill sets programmed for various players depends on the sport and level of competition sought by the association for a particular league.

Following the completion of a player draft, the teams are now set in a specified time period, for example two weeks, is allowed to elapse before the first game of the season in a conference. The time is allowed to elapse in order to allow franchise owners to establish plays and prepare game plans and profiles for the season. A method and apparatus according to the invention includes a play editor. The play editor allows the franchisee to develop and record individual plays and assign players to positions needed to execute the plays. For example, based on the available players acquired through the draft, the franchisee may elect to assign a particular player to receive a forward pass from the quarterback as part of a particular play. The pass completion rate will depend on the ratings of the passer, the receiver, the defender, and the field position according to predetermined parameters that executes the actual game. Programs to execute plays and games using such criteria are known in the art. Those of ordinary skill will recognize that any such programs could be used in keeping with the invention. The franchisee can experiment with plays using the play editor at his own virtual training facility, where the franchisee can setup plays and execute them with or without a set of defenders or offensive players and formations. Thus, according to the invention a franchisee using a training facility can setup a scrimmage among the franchise's players to test the viability of various plays.

A profile editor enables franchise owners to participate in a game without having to sit at a console or at a computer to play the game. Another element of game preparation step 204 concerns the development of a game profile through the profile editor. The profile editor program according to the invention is programmed with the plays the franchisee elects to run in certain situations. In an automatic mode, for example, when a particular situation such as first down with ten yards to go inside the twenty yard line arises, the franchisee may program the profile editor to execute a particular play. Alternatively, the franchisee may elect a different play under different conditions, for example where the franchisee's team is seven points behind, ten yards from the goal line and in the third quarter of the game. The profile editor provides additional options including a script of plays which the franchisee may execute at various points in the game. For example, the franchisee may elect the first fifteen or twenty plays of the first quarter to be “scripted” such that the program executes a particular sequence of plays. A franchisee may elect such a strategy in order to assess the strategy of the opposing team. An audible plan editor allows a franchisee or team to execute “audibles.” In that context, the franchisee elects to change the play when the opposing team lines up in a pre-determined formation. For example, the franchisee may elect to change from a pass play to a running play depending on the formation lineup of the defensive team. A method and apparatus according to the invention allows keys on the keyboard to be assigned as audibles referred to as hot keys. This allows the team to manually interact with the game controller in real time to “audible” the play.

After a team has designed and tested its plays, developed a game plan and profiled the series of plays with the profile editor, the team submits game plans to a game controller or game plan coordinator. The game plan coordinator or controller residing on a server provides franchise owners access at a scheduled time to play a game. As in other professional leagues, games are scheduled to take place at fixed times on fixed dates. In order to avoid problems caused by franchise owners who fail to appear for a game, the game coordinator must have at least one game plan available for use at all times if the franchise owner does not sign in at the scheduled time. The game coordinator will then execute the franchise owner's stored game plan. The franchise owner can store more than one game plan on the game coordinator engine. Storage limitations may require limiting the number of game plans a franchise owner can store on the server. By way of example and not limitation, the game coordinator would require that each franchise owner store at least one and not more than three game plans which would be executed on game day at the scheduled time, unless the franchise owner signs in to conduct his own game.

The game coordinator also will execute the stored game plan in the event of disruption of the network connection from a franchisee during a game. For example, if a franchisee looses the connection to the server that cannot be restored, during the period of the outage the game coordinator will execute a stored game profile.

Where a franchisee at process 205 submits multiple game plans to the game coordinator, the game coordinator can elect to execute the game plan specified by the franchisee that corresponds to the identity of the opponent. The franchisee can always confirm and track the game plans he submits to the game controller or game plan coordinator.

At process 206 the game plan coordinator initializes the game and begins executing the plan in accordance with the players identified. At process 207, the actual game is played under the control of the game coordinator. During play the game coordinator records game's and players' statistics, tracks the progress of the game and allows the playing franchisees to control the game according to their game plans and official game rules. Thus, the game coordinator is responsible to referee the game and to record its progress. The game coordinator also ensures that a game film is recorded so that the franchisees can purchase and observe each other's game films as part of the strategic football planning process.

FIG. 2 includes an additional block 208 for roster rroves. In the draft and player assignment process, it is possible, and indeed likely, that franchisees will not obtain the optimum mix of players. Therefore, the method and apparatus according to the invention provides a time period after the player draft during which franchisees can negotiate player trades. By way of example and not limitation, for a football league with a schedule of seven regular games, trades could be allowed for up to three weeks into the season.

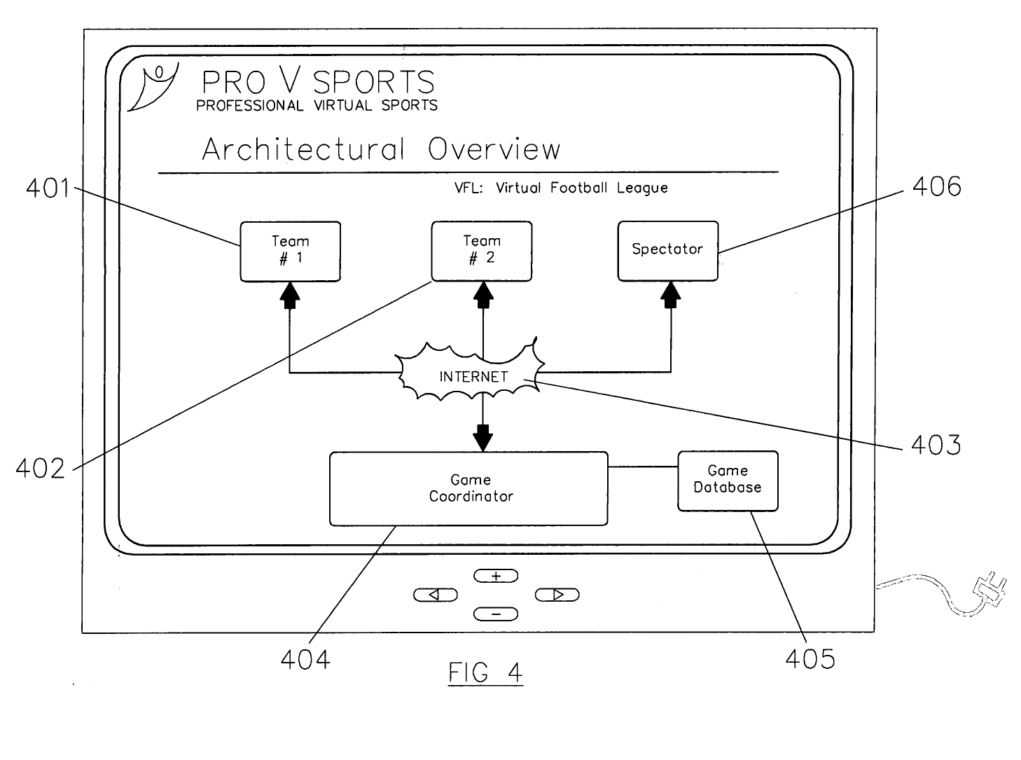

FIG. 4 is a high level architectural overview of a network implementing a method and apparatus according to the invention. FIG. 4 shows teams 401 and 402 connected to a network, such as the Internet, 403 to conduct a game for a game coordinator or controller. Each player has a computing device and a display which allows the players to observe the progress of the game as it continues. Each computer also contains local storage for statistics, game plays and game plans each player might wish to use. Game coordinator engine 404 resides on a server managed by the league or the association. As previously noted, the league sets a game schedule so that each game begins at a specific date and time. At the appropriate date and time the game coordinator engine initiates play between the teams scheduled to compete at that time. The game coordinator engine has a game database 405 which stores game statistics and films and game plans. As previously noted the game coordinator engine will execute a backup game plan in the event that a franchise owner fails to connect for the scheduled game or looses his connection at some point during the game.

The architectural overview in FIG. 4 also shows spectator 406 connected to observe the game. The game coordinator verifies that team 1 and team 2 have team status and assigns all others connected to the site to observe the game the status of spectator, so that spectators can not interfere with the progress of the game.

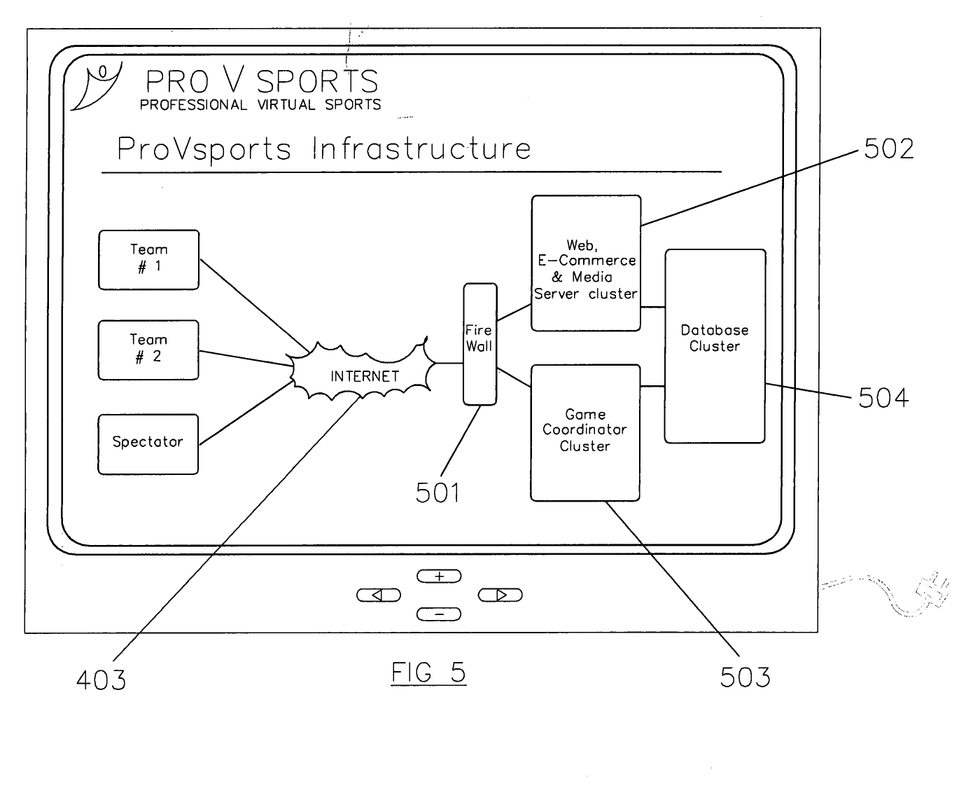

FIG. 5 provides a more detailed view of an infrastructure that can be used to carry out the invention. As previously noted teams 401 and 402 and spectator 406 are connected through an Internet connection 403 and a firewall 501 to the game controller to control and execute the game functions. Typically, this comprises one or more web servers 502, game coordination servers 503 and database servers 504. The game coordination engine may require intense processing and intercommunications with the teams. Therefore, a cluster of game coordination servers can be maintained at various geographic locations in order to relieve network congestion and provide the necessary computing capacity. Realistic game software may require intense video processing and require bandwidth that precludes heavy reliance on a smaller number of game coordination servers. The information required by the game coordination servers from a database, however, is relatively constant. For example, the performance parameters of a particular player are relatively constant, at least for the duration of the game. Thus, fewer database servers may be necessary to carry out the features of the invention. The web server 503 is useful to provide administrative services and other computer services without interrupting the process of the game and dedicated game coordination servers. Those of ordinary skill will recognize, however, that the infrastructure disclosed is by way of example and not by limitation. Other infrastructure configurations may function as well to carry out the invention

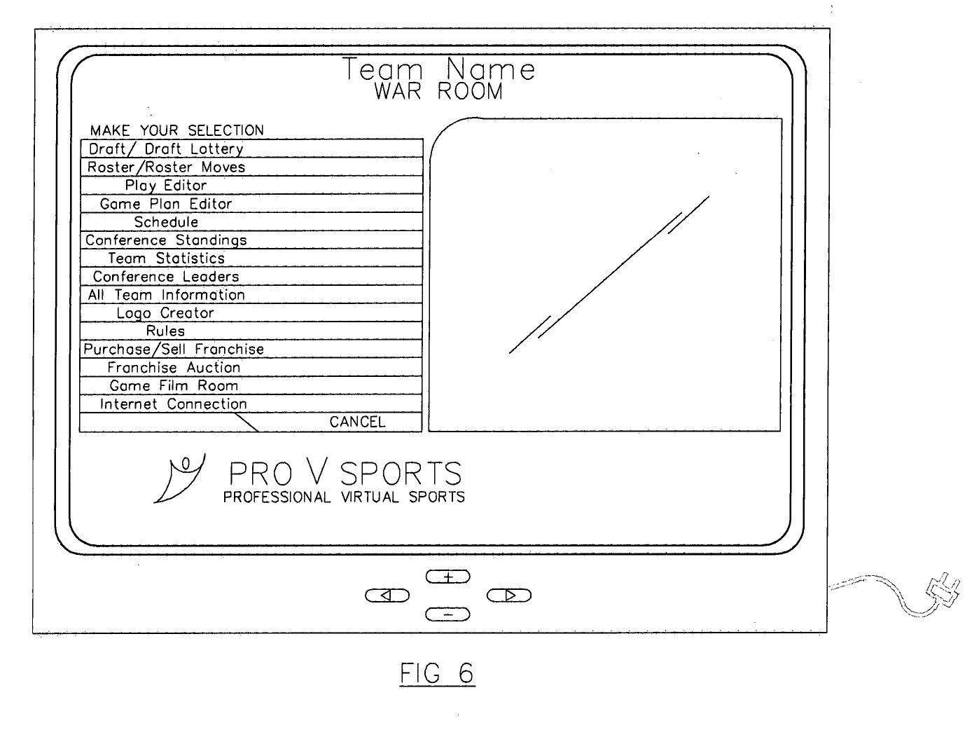

FIG. 6 is an illustration of a menu display useful for carrying out the invention. Those of ordinary skill will recognize that the; illustration is by way of example and not limitation, since other displays could be equally effective at carrying out the invention. The function of the menu is to allow the franchisee access to the various features of the method and apparatus of the invention. For example, the franchisee would move a mouse to highlight the draft/draft lottery box to access the player draft features of the invention. Similarly, the user could access the play editor to edit plays, or the game plan editor to edit a game plan. Those of ordinary skill will recognize that selecting one of the options will result in the program executing steps to display additional screens needed to guide the franchisee or user in carrying out the selected function.

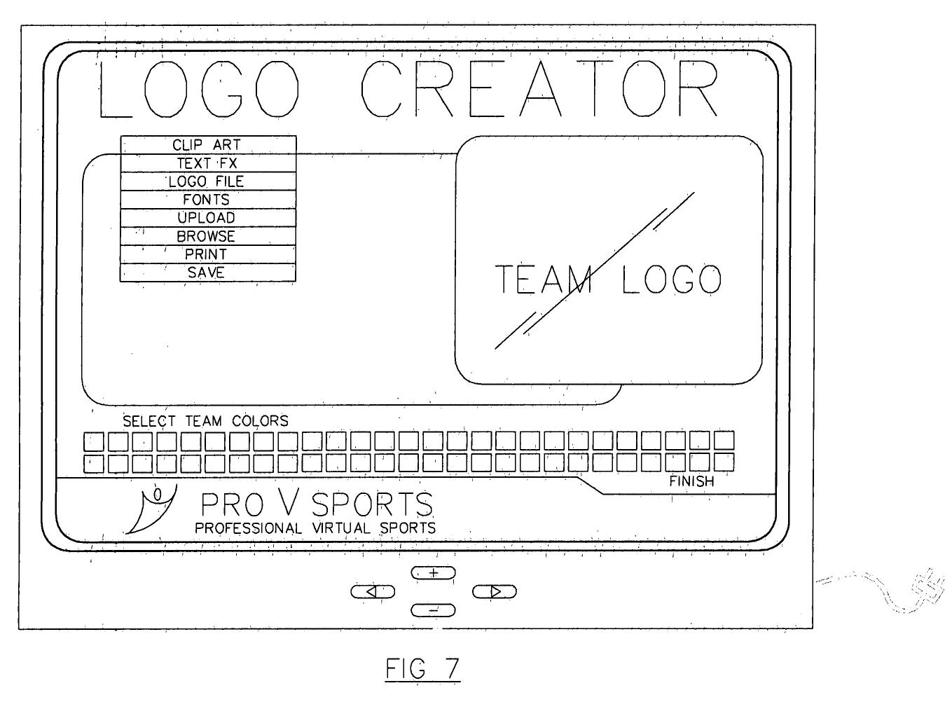

FIG. 7, by way of example and not limitation, illustrates one example of a logo creation screen the system could display to the user. The selections permit the user to use a logo from an existing logo file stored in the association or league database, to select clipart stored either in the database or on the compact disk, to browse other features, select team colors, select print fonts and print and save the selected logo. The user can then port that logo to the franchise's own virtual home field, locker room, training facilities and uniforms. Thus; when the franchisee is practicing plays at its training facility the franchisee's logos appear on the screen. Similarly, when a game is scheduled at “home” for the franchisee, the franchisee's own logos will appear for example at the center of the field and in the end zones.

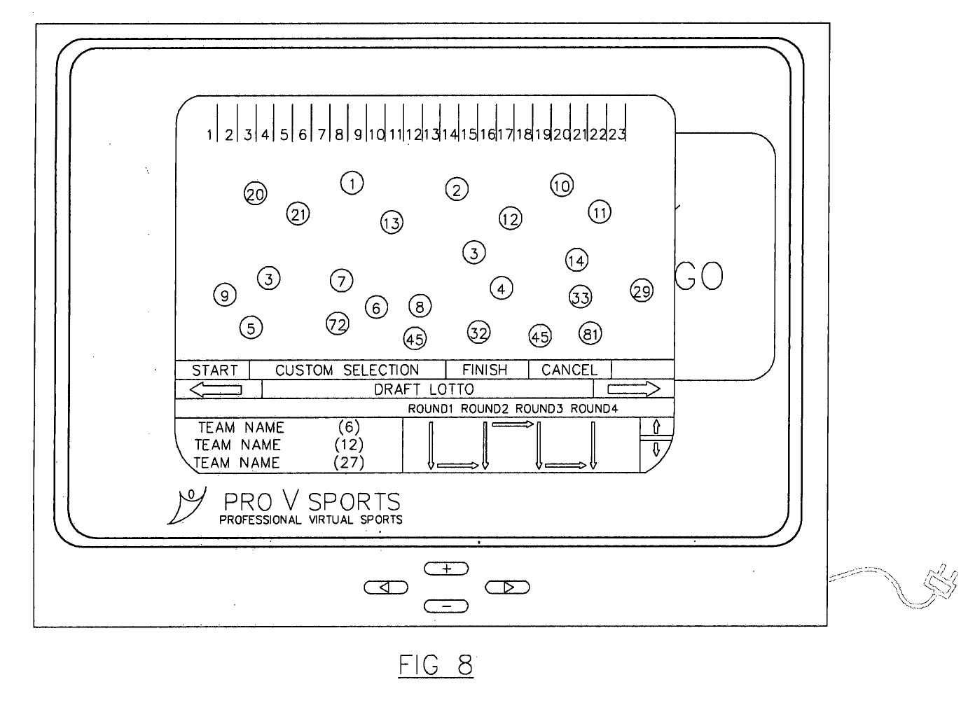

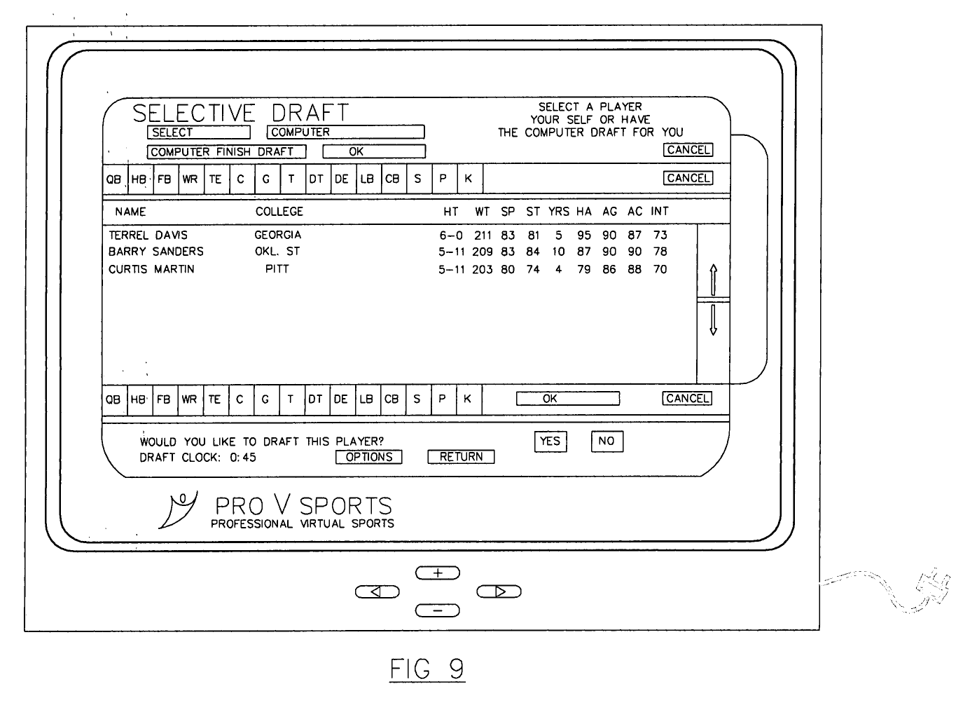

FIGS. 8 and 9 illustrate features of the player draft lottery. The player draft takes place at a scheduled date and time. Each franchisee is assigned a position in the draft by lottery. Franchisees select players from a pool of available players in order as their lottery numbers indicate in the first round. In the next round franchisees select from the remaining players in the pool in reverse order of the first round. The third round reverses the order again and so on. Each franchisee has a limited amount of time, for example, forty-five seconds, to elect a player in each round of the draft.

FIG. 8 illustrates the draft lottery process showing the positions of the various teams to select players in the draft.

FIG. 9 illustrates a display a franchisee uses to indicate a draft selection by highlighting the player and answering the question as to whether to draft the player with a “yes”. FIG. 9 indicates that the display includes the name and college of the player, the player's statistics and position.

A method and apparatus according to the invention also allows the franchisee to establish a draft profile which will be executed by the computer in the event that the franchisee is unavailable to participate in person at the draft. The franchisee can elect a program the draft profile to select a particular player if available on any particular draft round. Alternatively, the franchisee can instruct the draft profile to fill a particular position in each draft round. Strategy is entirely up to the franchisee. After establishing the draft profile, the franchisee transmits the draft profile to a server who conducts the draft for the franchisee in accordance with the profile. While the draft is going on, the franchisee can take control over the profile at any point in time or relinquish manual control and turn control over to the draft profile.

As previously noted, after completion of the draft franchisees have a specific amount of time to design and experiment with plays before the first game occurs. By way of example and not limitation, the first game could be scheduled between two and three weeks after the completion of the draft. During this time franchisees can develop plays using a play editor program.

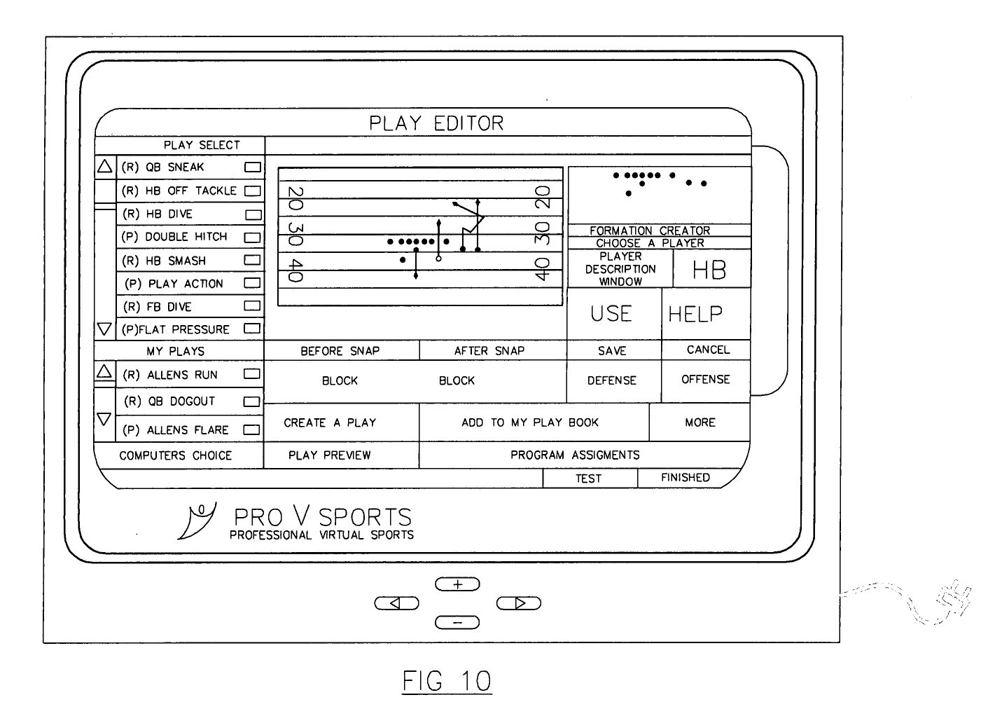

FIG. 10 illustrates the display for one possible play editor that would be useful in football. Those of ordinary skill will recognize that other display formats for football may be useful as well, and that other display formats for other sports and applications may be useful. The invention is not limited by the display format or the display content, to the extent that the display content is not dictated by the features of the invention, but is only dictated by the parameters of the game or exercise underway.

By way of illustration, the play editor in FIG. 10 has a number of elections or options particularly relevant to the game of football. The upper right-hand section of the display includes a formation creator where one can establish the formation for an offensive or defensive line. The left side of the display includes a menu that allows the user to select from a library of existing plays or from another library of plays developed specifically by the franchisee.

The center of the display produces a traditional play illustration. Immediately below the center of the display are a number of buttons or keys such as look for, pass, or block, that are related specifically to football. For example, one could click or load a play to develop his own play or to observe a play. Players can be programmed for assignments by clicking on the players and using the buttons at the bottom of the screen to program their logic. Example: Block, Handoff or Look For Pass. The play editor display also has buttons or keys to allow the user to save the play. Since certain actions may take place both before and after the “snap” of the ball, the play editor provides for programming the play both before and after the snap.

Having created a play, the franchisee can save the play to a file and use the play in a practice mode in his own virtual training facility. For example, the franchisee can execute an offensive play against his own defensive team to determine whether the play is viable for use against opponents. A system according to the invention, also has an instant replay capability which permits the franchisee to view the play frame by frame or real time and determine the effect. When the franchisee is satisfied with the play he can then store that play for later use.

As previously noted, a series of plays form a game plan which is then sent to a profile editor for a particular game. The profile editor stores the plays that the franchisee elects to execute depending on the circumstances of the game. For example, in circumstances where the team is behind by seven points and within ten yards of the goal line, the franchisee may program the profile editor to automatically execute a running play using specific plays and/or players. This is a manual approach in which the franchisee specifically identifies those plays that should be executed under certain circumstances. The profile editor also provides an automatic option. Here, the profile editor automatically creates a situation which the franchisee responds to and is then used to automatically create the game profile. The game profile can include criteria for determining whether to attempt to score a first down or touchdown or elect to try for field goal. Similarly, the profile editor can be programmed with criteria to decide whether a team will seek to accomplish a one or two point conversion after a touchdown, in various circumstances. The profile editor can also be programmed to determine the circumstances in which the team will elect to decline or accept a penalty on the opposing team. In addition, the profile editor can be used to “script” plays in a game such that under certain circumstances a team executes a certain sequence of plays regardless of other game considerations. For example, it might be useful at the beginning of a game to execute the first ten or fifteen plays in a particular sequence in order to determine the response posture of the opposing team. In addition, the profile editor can be used to program the percentage of time a play will be used in a particular or specific situation.

In order to add realism to a game, penalties occur in a pseudo-random fashion based on performance ratings from previous years for the players involved. Such ratings include speed, ball handling, and other factors. For example, a player who jumps off sides on a relatively frequent basis is likely to have a higher incidence than a player who rarely jumps off sides. Similarly, algorithms that evaluate factors such as the rate of pass completion, dropped balls, and other factors are used to determine the probability of success for pass completion and running plays. Such algorithms are known in the art as are programs to execute plays.

Players can be assigned fatigue and recovery time ratings that a franchisee can consider in electing player substitutions. For example, a player's performance will decline as the player's fatigue level rises. The player's fatigue level is typically a function of the number and type of plays the player executes. The substitution editor can be programmed by the franchisee to substitute players as their fatigue level rises.

The audible play editor can also be programmed to change the play if the opposing team lines up in a predetermined formation. In actual game conditions when the other side lines up in a particular formation, a play can audibly change the formation and assignments, as permitted by the rules of the game. Since this is typically an instantaneous decision, the profile be programmed to recognize certain formations and to issue an audible command which results in changing the lineup of the responsive team. Alternatively, audibles can be programmed to individual keys referred to as “hot keys.” The hot keys can be dedicated to a whole play or to an player's role. For example, a franchisee can program a hot key the pass route for a particular play. According to a method and apparatus of the invention, the assignment of the hot keys can be reviewed so that it is not necessary to remember them all.

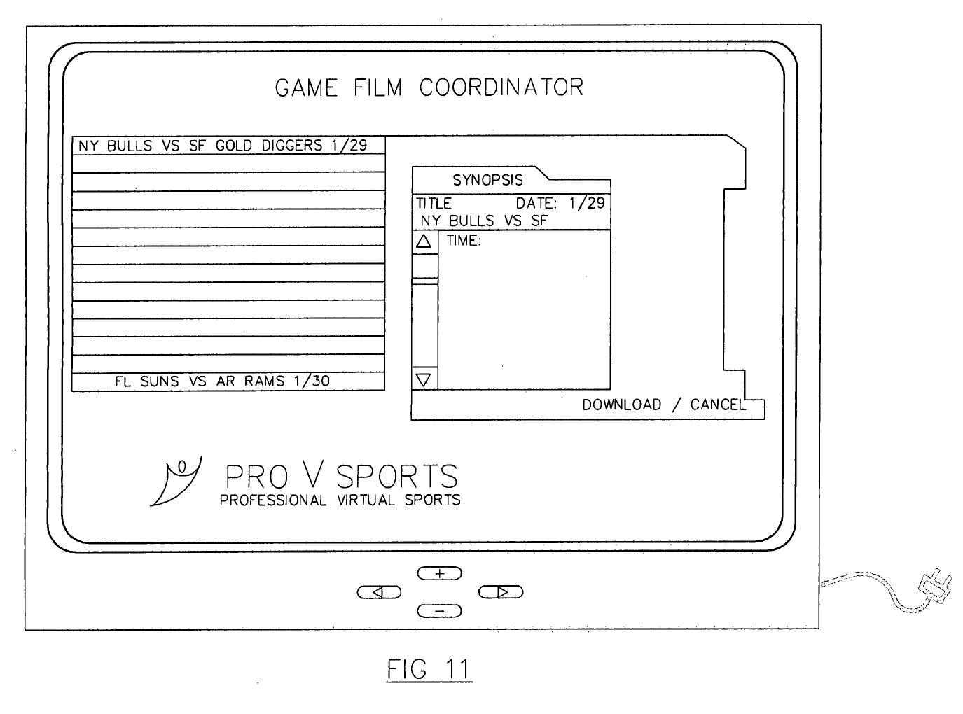

As previously noted, the game coordinator residing on a server managed by the league or the association performs the administrative functions associated with operating the game. Included among these administrative functions is recording game statistics and creating a game film. FIG. 11 illustrates selection of the game film from the game film library. By highlighting a game of interest, one receives a synopsis of the game and can elect to download the entire game film. Downloading the game film is particularly useful in planning strategy against another team or opponent.

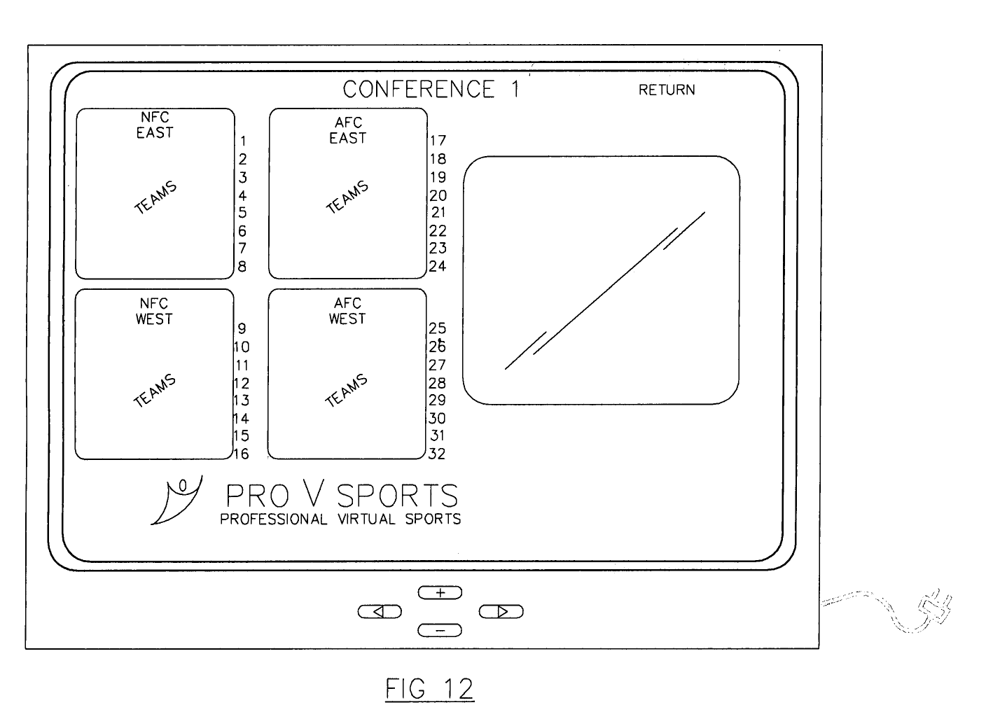

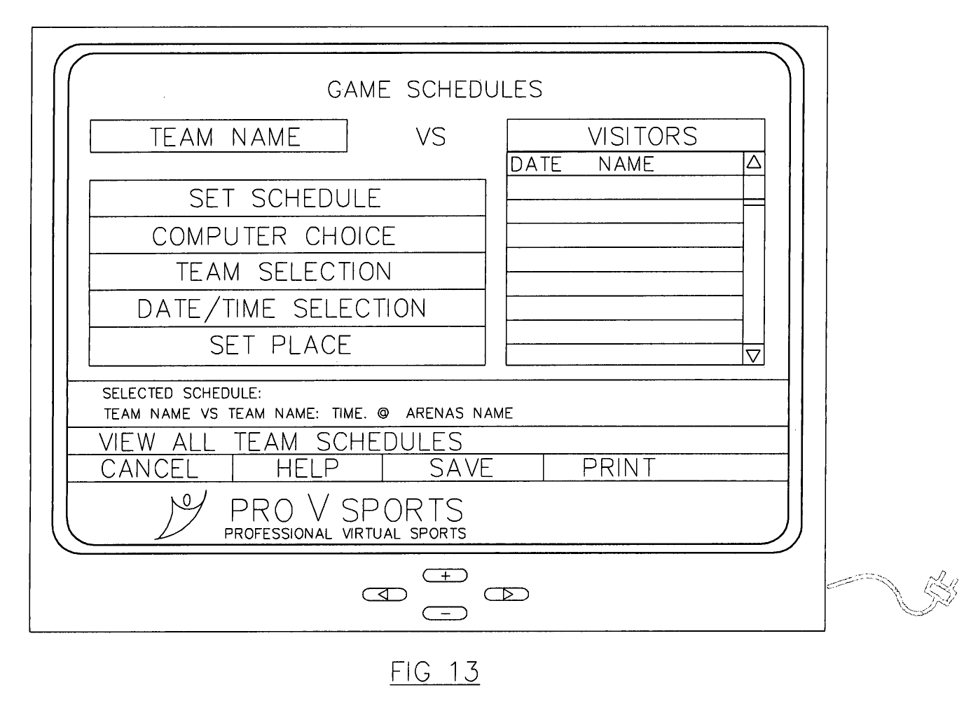

The standings and schedule at any point in time during the season are particularly important in evaluating one's potential for admission to post-season playoffs. FIG. 12 provides one illustration of a standings display. FIG. 13 provides a game schedule display. The game schedule display is useful for identifying a team's future opponents so that the franchisee can observe films of that particular team and optimize the team's game plan.

The player draft previously discussed can be implemented in numerous ways. One option is to have two pools of eligible players. By way of example and not limitation, one pool could consist of players in a currently active professional football league, such as the National Football League. Depending on the number of franchises awarded a relatively large number of rounds in the draft can be executed. College players coming into the National Football League could be the subject of a second draft. Since there are fewer players entering the league each year than the number of players in the league, the number of college draft rounds would be smaller than the number of draft rounds for existing players.

As previously discussed each team has a home field and a training facility. The home fields and training facilities can be built out of templates which represent either real or fictitious stadiums and training facilities. As previously noted each team selects a logo and can port that logo onto the template for the training facility and the home field. When a team is scheduled to conduct a game at “home,” both teams appear on the field of the home team. This provides an opportunity for the home team to sell advertising at various points in the stadium that would be observed during the game. As another feature of the invention is the ability to advertise other products on the templates of the home team, since spectators would seek display of these advertisements.

Since various home teams play in different stadiums under different weather conditions, weather conditions can also be simulated according to the invention. For example, teams playing in a hot or cold climate could experience unusual rates of fatigue based on he weather conditions. In addition, the number of fumbles and drop balls could be increased in rainy or snowy conditions likely to occur at certain home fields.

Another feature of the invention provides a “coaches edition” of a play editor. The coaches edition would allow the coach to access the ratings of players in the play editor and evaluate the effect that would occur if the player had different playing characteristics. While it would be impossible to change the characteristics of the individual player, such information could guide the coach in selecting new players in a new draft or in trading existing players for others.

It will thus be seen that the objects set forth above, among those made apparent from the preceding description are efficiently attained and since certain changes may be made in the above construction without departing from the scope of the invention, it is intended that all matter contained in the above description or shown in the accompanying drawing shall be interpreted as illustrative and not in a limiting sense.

It is also to be understood that the following claims are intended to cover all of the generic and specific features of the invention herein described, and all statements of the scope of the invention which, as a matter of language, might be said to fall therebetween.

Now that the invention has been described,

What is claimed is:

1. An interactive game for game play between competing teams over a network, said interactive game comprising a game site including a game controller to coordinate said interactive game at said game site between competing teams, each competing team having a processor to create game instructions for each said competing team.

2. The interactive game of claim 1 wherein each said processor comprises an input device to input game instructions to a memory, a communications device to transmit said game instructions to said game controller and a display that allows each said competing team to observe the progress of each said interactive game in real time.

3. The interactive game of claim 2 wherein each said competing team is registered with said game controller for setup and configuration each said competing team, said setup and configuration of each said competing team comprising the selection of a team name and team logo.

4. The interactive game of claim 3 wherein said team name and said team logo are imported onto each competing team facility and team uniforms.

5. The interactive game of claim 4 wherein said team logo is displayed on a home field.

6. The interactive game of claim 3 wherein said team logo of said team is selected from a database comprising a plurality of preexisting logos.

7. The interactive game of claim 3 wherein each said team logo is created by each said team.

8. The interactive game of claim 1 wherein each said competing team is assigned a discrete identification indicator to allow interactive game play over the network.

9. The interactive game of claim 8 wherein said interactive game comprises a league of at least one conference.

10. The interactive game of claim 9 wherein each said competing team is assigned to a conference.

11. The interactive game of claim 10 wherein said league includes single elimination play off format.

12. The interactive game of claim 9 wherein said conference has at least a first predetermined number of teams and no more than a second predetermined number of teams.

13. The interactive game of claim 12 wherein said conference has at least 8 competing teams and no more than 32 competing teams.

14. The interactive game of claim 11 wherein the total teams assigned to a conference is determined by dividing the total number of teams available by 2ⁿ where n is a whole number.

15. The interactive game of claim 14 wherein said conference has at least a first predetermined number of teams and no more than a second predetermined number of teams.

16. The interactive game of claim 15 wherein said conference has at least 8 competing teams and no more than 32 competing teams.

17. The interactive game of claim 1 said game controller stores each game played to create and maintain a game film of each said game played to permit selective access by said competing teams to view said accessed games.

18. The interactive game of claim 17 wherein said competing team elects to selectively access said game plans at said setup and configuration.

19. The interactive game of claim 1 further comprises each said competing team selects players from a draft pool.

20. The interactive game of claim 19 wherein each said competing team selects players in order determined by a lottery.

21. The interactive game of claim 20 wherein order of selection in each subsequent round of a multi round lottery is in reverse order of selection of the next previous round.

22. The interactive game of claim 20 wherein each said competing team creates a draft profile of players desired to be selected to be executed by said game controller and transmits said draft profile to conduct the draft for said competing teams in accordance with said draft profiles.

23. The interactive game of claim 22 wherein each said draft profile comprises selecting a particular player if available.

24. The interactive game of claim 23 wherein each said draft profile further comprises selecting a player for a particular position.

25. The interactive game of claim 24 wherein each said competing team selectively controls said draft profile.

26. The interactive game of claim 22 wherein said draft profile comprises selecting a player for a particular position.

27. The interactive game of claim 26 wherein each said competing team selectively controls said draft profile.

28. The interactive game of claim 22 wherein each said competing team controls the draft profile.

29. The interactive game of claim 1 further comprises a play editor to create a plurality of plays selectively executable by said game controller during a game.

30. The interactive game of claim 29 wherein said play editor is operable in a play design mode to establish play formations and corresponding executable play assignments for each player for each play.

31. The interactive game of claim 30 wherein said play editor further is operable in a practice mode to view the execution of said plays and to selectively modify the corresponding play formations and corresponding executable assignments.

32. The interactive game of claim 31 wherein at least one specific player is assigned to a specific position in said corresponding executable assignment.

33. The interactive game of claim 32 wherein said plays are stored in a data base.

34. The interactive game of claim 30 wherein specific skill sets are established for at least one of said specific positions and specific skill levels for said specific skill sets are assigned at least one player for said specific position.

35. The interactive game of claim 34 wherein at least one specific player is assigned to a specific position in said corresponding executable assignment corresponding to said skill level of such players and corresponding play formation.

36. The interactive game of claim 35 wherein said play editor further is operable in a practice mode to view the execution of said plays and to selectively modify the corresponding play formations and corresponding executable assignments.

37. The interactive game of claim 36 wherein said plays are stored in a data base.

38. The interactive game of claim 37 further comprising a profile editor to receive a set of plays selected by said play editor to be played during a game comprising a game plan and to create a game profile to select executable plays from said game plan for predetermined game situations.

39. The interactive game of claim 38 wherein said profile editor is operable in an automatic mode to select a specific play to be executed in response to a predetermined situational criteria.

40. The interactive game of claim 39 wherein said profile editor selects said specific plays a predetermined percentage of times of each said predetermined situational criteria.

41. The interactive game of claim 39 wherein said profile editor is operable in a script mode to execute a predetermined sequence of plays for said game plan.

42. The interactive game of claim 41 wherein said profile editor is further operable in a manual mode whereby plays are individually selected.

43. The interactive game of claim 43 wherein said game profile is stored in said processor and transmitted to said game controller to be executed during game play between competing teams.

44. The interactive game of claim 39 wherein said profile editor is further operable in an audible mode to automatically change the play selected for execution when the opposing team is in a predetermined formation.

45. The interactive game of claim 44 wherein said audible mode is executable by said corresponding processor.

46. The interactive game of claim 45 wherein said game profile is stored in said processor and transmitted to said game controller to be executed during game play between competing teams.
